(19) United States
(12) Patent Application Publication
(10) Pub. No.: US 2012/0008251 A1
(43) Pub. Date: Jan. 12, 2012

(54) Film capacitors comprising melt-stretched films as dielectrics

(76) Inventors: Wei-Ching Yu, Marietta, GA (US); Jason Yu, Marietta, GA (US)

(21) Appl. No.: 12/805,104

(22) Filed: Jul. 12, 2010

(51) Int. Cl. H01G 4/18; H01G 4/06; H01G 4/008

(52) U.S. Cl. 361/305; 361/323; 361/311; 428/220

(57) ABSTRACT

A film capacitor comprising (1) of electric conduction electrodes and (2) of semi-crystalline polymeric dielectric film(s), the thickness of which ranges from 1 micron to 80 micron, made by a melt-stretching extrusion process through a die (circular die or flat die) with a drawdown ratio of 30 or higher (the ratio of die gap to the film thickness) at die temperatures higher than the melting point of said semi-crystalline polymer(s). The semi-crystalline polymeric dielectric films made by such melt-stretching extrusion process show a significantly low shrinkage at high temperatures until they are melted. The capacitor comprising such low shrinkage film dielectrics can be used at a much higher temperature than comprising conventional biaxially oriented film dielectrics made of the same plastic materials.

### CROSS-REFERENCE TO RELATED APPLICATIONS

Not Applicable.

### FEDERALLY SPONSORED RESEARCH OR DEVELOPMENT

Not Applicable.

### BACKGROUND

Film capacitors come in two broad categories: metal-foil-film construction and metalized film construction. Foil-film capacitors are made of alternating layers of plastic film and metal foil as electrodes, while metalized film capacitors have the metal vacuum deposited directly on the films as electrodes.

For the film capacitors, the film dielectrics can be made of polyphenylene sulphide (PPS), polystyrene (PS), polycarbonate (PC), poly(ethylene terephthalate) (PET), poly(ethylene naphthalate) (PEN), polyvinylidene difluoride (PVDF), high-density polyethylene (HDPE) or polypropylene (PP).

Take an example of the conventional BOPP film dielectrics. The conventional BOPP films, oriented biaxially at temperatures below the melting point of PP after cooled from extrusion, have been widely used as dielectrics in many different kinds of film capacitors. The PP material is relatively low cost. Its film dielectric provides (1) low dissipation factor as a function of temperature, (2) high breakdown strength and (3) excellent self-healing properties via metallization as electrodes. However, the thermal dimensional stability of the BOPP film dielectric is limited typically only up to 105° C. although its melting point is as high as 163 ° C. It is almost 55-60° C. below the melting point. The low thermal dimensional stability is due to its low orientation temperatures. With this low level of thermal dimensional stability, it is not suitable for the application of capacitors in self-heating or heated environments, such as pulse power capacitors, automotive capacitors and surface mount capacitors. If used as the surface mount capacitor, the capacitor comprising the conventional BOPP film dielectrics can not stand the heat conducted from soldering during mounting. For such an application, typically the film dielectrics need its thermal dimensional stability at least up to 125° C. If it has to be used in a self-heating or heated environment for the excellent properties described above, the film capacitors comprising the conventional BOPP film require to be used in conjunction with a cooling system, which adds up the cost and the space undesirably.

In general, biaxially oriented films as dielectrics in the film capacitor application tend to be not very thermally dimensionally stable. Another common example is biaxially oriented PET film dielectric. Its dimensional stability is only up to about 125° C. although its melting point is as high as 250° C. or higher. It is 125° C. below the melting point.

These biaxially oriented films are generally stretched at temperatures below the melting point of the material. After stretched, the films tend to retract back when they are reheated close to that stretching temperature.

Attempts had been made to improve the thermal stability of capacitors comprising conventional BOPP film dielectrics at a higher temperature.

U.S. Pat. No. 6,127,042 presented capacitors' comprising a high modulus PP film having improved percentage of heat-shrinkage over prior arts in the machine direction about 1.9% at 120° C. and about 2.5% at 140° C. The shrinkage remained too high for high temperature application.

U.S. Pat. No. 6,687,115 presented a capacitor² comprising a conventional PP film as a dielectric and two metal electrodes. For improved thermal stability, the capacitor has to be then heated up to a very high temperature range (from 120° C. to 200° C.) very slowly under vacuum and then cooled down. After such treatment, the capacitor can stand a higher thermal stability than the conventional one. However, this technology would not be as practical as the conventional one. First, the electrodes need metal electrodes, excluding the possible application in metalized film capacitors. Secondly, the process of making such a capacitor is imagined to be very time consuming. Even if extra time consumed is acceptable, by extra process steps (vacuum, heating and cooling), the capacitors will cost more to make.

In this invention, the film capacitors are made with melt-stretched semi-crystalline film dielectrics having a much higher dimensional stability at higher temperatures than with the conventional biaxially-oriented film dielectrics made of the same raw materials.

### SUMMARY OF THE INVENTION

In this invention, the film capacitors are made with melt-stretched semi-crystalline film dielectrics having a greatly improved dimensional stability (less than 1% shrinkage in MD and in TD) at a temperature as high as right below the melting point of the semi-crystalline films. The film capacitors can be either in foil-film construction or in metalized film construction. The film capacitors comprising such improved dimensionally stable film dielectrics can be used at temperatures much higher than those comprising conventional biaxially-oriented film dielectrics made of the same raw materials.

### LIST OF FIGURES

FIG. 1 Free Shrinking of Dielectric Film A and BOPP in a Convection Oven for 30 min

FIG. 2 Comparison of Free Shrinkage of HTLS PP (Dielectric Film A) and BOPP at specified temperatures for 30 min.

FIG. 3 Temperature Dependence of Capacitors with HTLS PP film (Dielectric Film B)

FIG. 4 Temperature Dependence of Capacitors with HTLS PP Film (Dielectric Film B) (Capacitors Reheated)

### DETAILS OF SPECIFICATIONS

The uniqueness of the film capacitors in this invention is the highly dimensional stable film dielectrics at higher temperatures. In this invention, the film dielectrics are made of semi-crystalline polymers by a unique melt-stretching process. Such film capacitors can be made into two types for different applications: metal-foil film type and metalized film type.

### Melt-Stretching Process:

In this invention, the melt-stretching process is a process of pulling molten semi-crystalline polymer(s) mono-axially in the machine direction and then of quenching the pulled molten polymers into a film via crystallization by a quenching medium, such as air, water or quenching rolls. The melt-stretching process can be readily achieved by an extrusion melt-stretching process. One of the examples for the extrusion melt-stretching process includes the following steps. The molten semi-crystalline polymer(s) can be plasticated by an extruder first and then extruded through a narrow die gap. The molten polymer(s) is then pulled at a much faster speed than the speed of the molten polymer at die exit and immediately quenched with a quenching medium at a location about 0.05-3 inch away in the machine direction from the die exit to form a film via crystallization. The die can be either a flat die or a circular die. The quenching medium can be quenching roll(s), water or air. The melt-stretched semi-crystalline polymer film(s) obtained shows dimensionally stable (an extremely low shrinkage, less than 1%) at temperatures as high as right below the melting temperature of the crystals in the semi-crystalline polymer(s). In general, the circular die and quenching chilled air are preferred for easy manufacturing and for more uniform properties.

In the extrusion melt-stretching process with a flat die, the molten polymer can be pulled from a flat die in the machine direction at a much faster speed than the molten polymer at the die exit At about 0.05-3 inch away from the die exit in the pulling direction, an air knife on one side of the molten film stream or two air knifes on each side of the molten stream (dependent on the degree of quenching needed) will be applied on the pulled molten stream. After quenched and partially crystallized, the obtained film shows an amazing dimensionally stable property at high temperatures.

The pulling process in the extrusion melt-stretching process with either the circular die or the flat die is achieved by pulling the cooled film at a much faster speed than the molten polymer at the die exit with a driven roll or a set of driven nip rolls.

In the extrusion melt-stretching process with a circular die, the molten polymer is extruded, quenched by an air ring at about 0.05-3 inch away from the die exit and pulled at a faster speed to form a film bubble. The film bubble is then collapsed by a set of nip rolls to form a two-layer film roll. Similarly to a flat die, the melt stretching with a circular die can be set up vertically upward, vertically downward, or horizontally. This is a unique blown-film process with a low blow-up ratio. The blow-up ratio is defined as the ratio of the bubble diameter to the circular-die diameter. In this invention, a blow-up ratio of 3 or less is preferred. With a lower blow-up ratio, it is easier to achieve the high dimensionally stable films at higher temperatures. However, an appropriate blow-up ratio for some degree of orientation in the transverse direction is needed to achieve better strength uniformity for a higher dielectric strength. Similarly to a flat die, the extrusion melt-stretching process with a circular die yields an amazing dimensionally stable film at high temperatures after extrusion, quenching and pulling at a faster speed than the extrusion speed of the molten polymers at the die exit.

During melt stretching, the drawdown ratio is defined as the ratio of die gap to the thickness of the obtained film. With a higher drawdown ratio, the melt stretching process yields a more dimensionally stable film at high temperatures. The preferred minimum drawdown ratio is 30. The higher end of the drawdown ratio can be as high as in the range of 250 and 300. However, with a too high drawdown ratio, the melt stretching process will yield a non-uniform film across the transverse direction. So, there is an optimted ratio, dependent on the material parameter, such as crystallinity and molecular weight. Another key factor affecting the orientation during melt stretching is the distance of quenching medium away from the die exit. The shorter distance imposes a higher strain to the molten polymer for a higher orientation of the finished film. A faster stretching speed imposes a higher strain rate to the pulled molten polymer for yielding a higher degree of orientation in the final film, which will enhance the dielectric strength of the film. Annealing at temperatures below the melting point can enhance the crystallinity of the film. The higher crystallinity of the film enhances the dielectric strength in general.

In summary, in the melt stretching process of this invention, the molten polymer is oriented right before it is cooled down by the quenching medium, like chilled air, to form finished film. The molecules are oriented in the molten state and then frozen into film. There is little residual stress or none left in the final oriented film and no shrinkage is observed with the film at temperatures below the melting point of the film. The oriented film from this invention can be oriented primary in the machine direction with a flat die and can be oriented both in the machine direction and in the transverse direction with a circular die when the blow-up ratio is greater than one. This is very different from the conventional bi-axially oriented process for conventional BOPP, conventional BOPET, and other bi-axially oriented films, which were made through a shaping process by quenching first, then a reheating process and finally a bi-axially orientation process sequentially.

### Semi-Crystalline Polymer(s):

Conventional or commercial semi-crystalline polymer(s) means crystalline polymers having less than 100% crystallinity. In this invention, the scope of the semi-crystalline polymers include (1) conventional or commercial semi-crystalline polymers or their copolymers, (2) the blends of such semi-crystalline polymer(s) with other polymers or with other additives, (3) monolayer of such conventional or commercial semi-crystalline polymers or their copolymers, (4) multilayer of such conventional or commercial semi-crystalline polymers and (5) a film comprising conventional or commercial semi-crystalline polymer(s). The semi-crystalline polymers in this invention can be melt-extruded, stretched from a die exit and then quenched and formed a film via partial crystallization by which an oriented macro-crystal structure is formed and fixed.

### Molten Polymer(s):

In this invention, the molten polymer(s) is defined as the heated semi-crystalline polymer(s) in which the crystals are melted by heat obtained through conduction or through friction. Usually, the crystal melting occurs at temperatures greater than the melting point. More practically, the molten polymer(s) is obtained through the plastication of extruder at temperatures 20˜60° C. above the melting point of the crystals. Exact conditions for appropriate molten polymer(s) in this invention depend on the properties of the semi-crystalline polymers and on the stretching processes chosen. Some examples of the conditions for molten polymers are described in the later Example Section.

### Features and Performance of Film Dielectrics Obtained in This Invention:

The films obtained by the melt-stretching process described in this invention show (1) an extremely high strength in the machine direction (MD) while a lower strength in the transverse direction (TD) and (2) an extraordinarily high dimensional stability (low shrinkages either in MD or in TD) at high temperatures. The anisotropic performance of the film strength in between MD and TD is due to the melt stretching primarily in the MD. The film made with a circular die can be controlled having some degree of orientation in the transverse direction by a blow-up ratio greater than one for a higher dielectric strength.

### Testing Methods:

MI: Melt Index ASTM D 1238; PE: 190° C./2.16 Kg;

MFI: Melt Flow Index. ASTM D1238;PP: 230° C./2.16 Kg.

Melting Point A thin slice of tested material (around 20 mg) is placed in an aluminum pan for differential scanning calorimetry (DSC) at a heating rate of 10° C./min starting from room temperature. The maximum endo-thermal peak is recorded as the melting point of the tested material.

Shrinkage Test: A film sample was marked with a 3-inch circle, held in a manila folder and put into a convection oven at a desired testing temperature for 30 min. After 30 min, the film was taken out of the oven and cooled down for determining the level of shrinkage. The shrinkage can be determined either by the ratio of the loss area to the original area or by the ratio of the lost linear length to the original length.

### Example of Dielectric Film A

A polypropylene resin with an MFI of 2.0 g/10 min and a melting point of about 165° C. was extruded on a 2-inch diameter extruder equipped with a 400-mm circular die. The temperature of the extruder and die was set at 220° C. An air ring was set on top of the circular die about 0.75 inch above the die face, and the melt stream was stretched through the air ring upward to a take-up nip roll set about 12 feet above the air ring at a stretching line speed of 26 meter/min. The drawdown ratio was 115, and the blow-up ratio of the bubble was about 1. The rotation speed of the extruder screw was adjusted to have a 12 micron film, and the pressure of quenching air was adjusted to have a smooth film. The stretched film bubble was collapsed into a two-ply film by a set of collapsing frame underneath the take-up nip-roll set. The two-ply film after passing the take-up nip-roll set was then wound up into a film roll.

### Example of Dielectric Film B

A polypropylene resin with an MFI of 2.0 g/10 min and a melting point of about 165° C. was extruded on a 1.5 inch diameter extruder equipped with a 400-mm circular die. The temperature of the extruder and die was set at 225° C. An air ring was sit on top of the circular die about 0.75 inch above the die face, and the melt stream was stretched through the air ring upward to a take-up nip roll set about 12 feet above the air ring at a stretching line speed of 22 meter/min. The drawdown ratio was 200, and the blow-up ratio of the bubble was about 1. The rotation speed of the extruder screw was adjusted to have a 6 micron film, and the pressure of quenching air was adjusted to have a smooth film. The stretched film bubble was collapsed into a two-ply film by a set of collapsing frame underneath the take-up nip-roll set. The two-ply film after passing the take-up nip-roll set was then wound up into a film roll.

### Example of Dielectric Film C

A polypropylene resin with an MFI of 2.0 g/10 min and a melting point of about 165° C. was extruded on a 1.5 inch diameter extruder equipped with a 400-mm circular die. The temperature of the extruder and die was set at 225° C. An air ring was sit on top of the circular die about 0.75 inch above the die face, and the melt stream was stretched through the air ring upward to a take-up nip roll set about 12 feet above the air ring at a stretching line speed of 22 meter/min. The drawdown ratio was 200, and the blow-up ratio of the bubble was about 1. The rotation speed of the extruder screw was adjusted to have a 4 micron film, and the pressure of quenching air was adjusted to have a smooth film. The stretched film bubble was collapsed into a two-ply film by a set of collapsing frame underneath the take-up nip-roll set. The two-ply film after passing the take-up nip-roll set was then wound up into a film roll.

### Example of Dielectric Film D

A high density polyethylene resin with an MI of 0.35 g/10 min and a melting point of about 132° C. was extruded on a 2-inch diameter extruder equipped with a 400-mm circular die. The temperature of the extruder and die was set at 195° C. An air ring was sit on top of the circular die about 1 inch above the die face, and the melt stream was stretched through the air ring upward to a take-up nip roll set about 12 feet above the air ring at a stretching line speed of 26 meter/min. The drawdown ratio was 156, and the blow-up ratio of the bubble was about 1. The rotation speed of the extruder screw was adjusted to have an 8 micron film, and the pressure of quenching air was adjusted to have a smooth film. The stretched film bubble was collapsed into a two-ply film by a set of collapsing frame underneath the take-up nip-roll set. The two-ply film after passing the take-up nip-roll set was then wound up into a film roll.

### Example of Dielectric Film E

A high density polyethylene resin with an MI of 0.35 g/10 min and a melting point of about 132° C. was extruded on a 1.5-inch diameter extruder equipped with a 400-mm circular die. The temperature of the extruder and die was set at 205° C. An air ring was sit on top of the circular die about 1 inch above the die face, and the melt stream was stretched through the air ring upward to a take-up nip roll set about 12 feet above the air ring at a stretching line speed of 26 meter/min. The drawdown ratio was 250, and the blow-up ratio of the bubble was about 1. The rotation speed of the extruder screw was adjusted to have a 5 micron film, and the pressure of quenching air was adjusted to have a smooth film. The stretched film bubble was collapsed into a two-ply film by a set of collapsing frame underneath the take-up nip-roll set. The two-ply film after passing the take-up nip-roll set was then wound up into a film roll.

### High-Temperature Low-Shrinkage (HTLS) Films

The most striking feature of the melt-stretched films is its very low shrinkage at temperatures as high as right below the melting point of the resin. Take Dielectric Film A as an example. Dielectric Film A is made of PP resin, which has a melting peak of 165° C. PP resin used herein is a semi-crystalline polymer. The crystals in semi-crystalline polymers usually start to melt a few degree C. before the peak, then go through the peak and then completely melt a few degree C. after the peak. So, at the peak temperature, the crystals in semi-crystalline polymers are not completely melted.

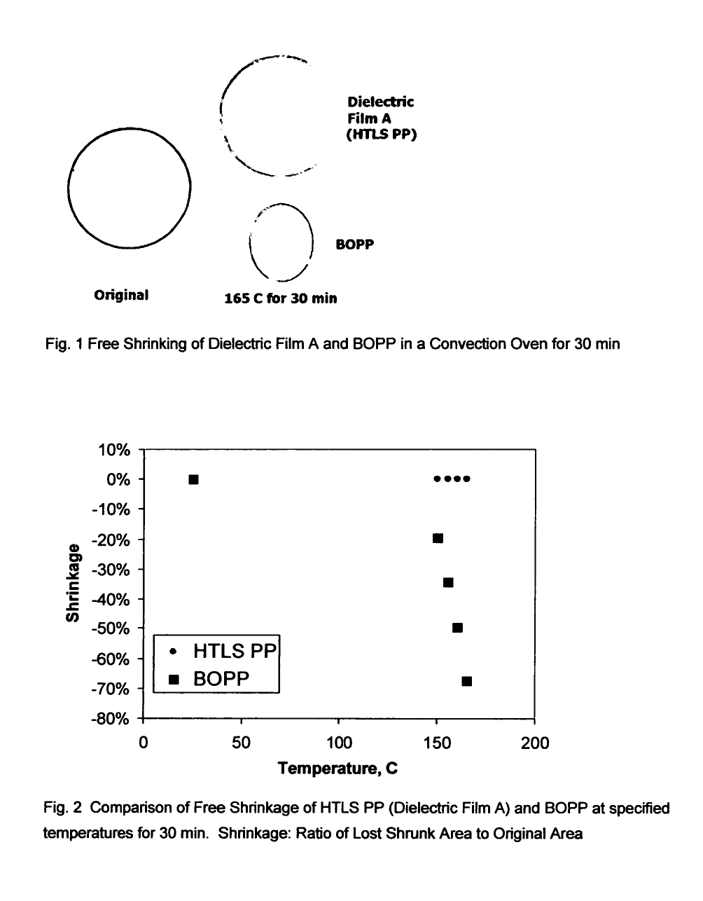

In a free shrinking test, Dielectric Film A was marked with a 3-inch circle, held in a manila folder and put into a convection oven at 165° C. for 30 min. After 30 min, the film was taken out of the oven for determining the level of shrinkage. No shrinkage at all was observed as shown in FIG. 1. In contrast, a commercial BOPP film was put together with Dielectric Film A in this free shrinking test. The commercial BOPP film shrank to 30% of the original circle with a net 70% loss in terms of area inside the circle. By the free-shrinking test, Dielectric Film A was also tested at other temperatures as shown in FIG. 2. Dielectric Film A showed a significantly more dimensionally stable than the conventional BOPP dielectric film and other prior arts of conventional BOPP dielectric film.

With the same PP resin, Dielectric Film B and C also behaved the same way as Dielectric Film A. In addition, with HDPE resin having a melting point of 132° C., Dielectric Films D and E showed no shrinkage at all at 128° C. in the same free shrinking test.

Examples of Film Capacitors with HTLS PP Film Dielectrics

Capacitors comprising HTLS PP film dielectrics can be either in foil-film construction or in metalized-film construction. They can be constructed in different sizes as needed for different applications. The process of making capacitors from HTLS PP film dielectrics should be similar to that from the conventional BOPP film dielectrics although the handling techniques may be slightly different.

### A. Foil-Film Construction

A combination of foil/Double-layer HTLS PP/foil/Double-layer HTLS PP was wound up into capacitors with extended foil electrodes at both ends. HTLS PP film used was 6-micron thick of Dielectric Film B. The total thickness of the film dielectrics between foil electrodes was 12 micron. The foils as electrodes were Al foils.

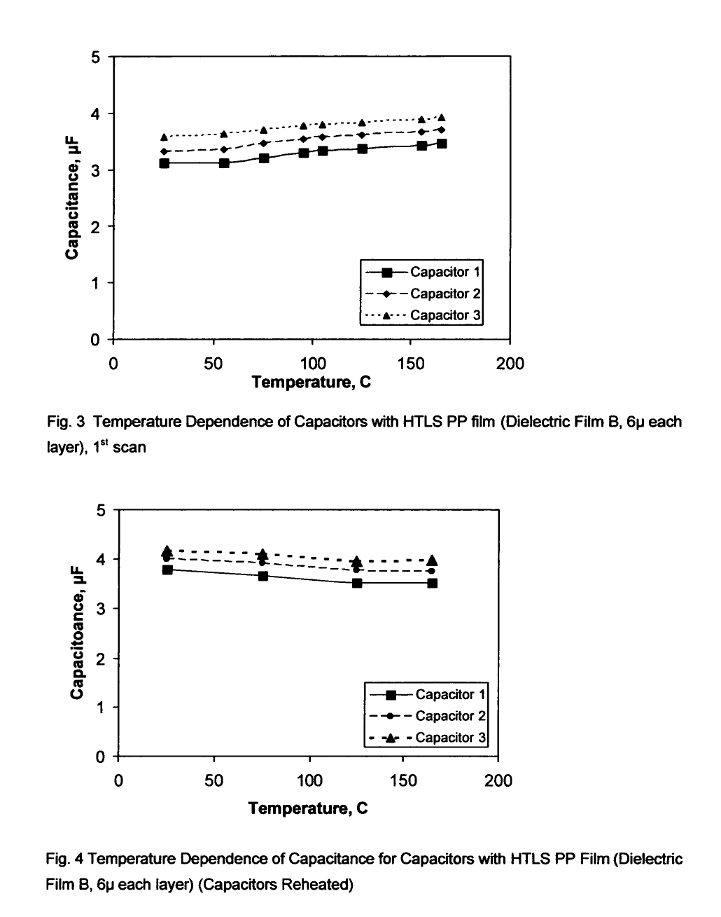

FIG. 3 shows the temperature dependence of capacitance of such foil/film capacitors. Basically, the capacitance maintains fairly constant from room temperature to the temperatures close to melting point. In the first temperature scan as shown in FIG. 3, the capacitance increase slightly instead of dropping. It is believed that the double-layer HTLS PP films were softened and brought together tighter. After cooled down to 25° C., the capacitance increased further due to the thickness contraction of the films, as shown in FIG. 4. When the capacitors were reheated to 165° C., the capacitances decreased to the level of the first scan at 165° C. The decrease in capacitance in the repeated run was initially observed about 5˜7% from room temperature to 165° C., which was believed due to the thickness expansion. No shrinkage of the films in the machine direction and in the traverse direction was observed after unrolling the capacitors through two cycles of temperature scan.

In a test of dielectric strength of capacitors (2.2 mF) in the same construction as in FIG. 3, the dielectric strength of such capacitors was as high as 1000 volt DC at 140° C., which was about the same performance as at room temperature.

### B. Metalized Film Construction

One of key challenges for metalized film capacitors is the metal end spray of capacitors for electrical connection to terminals. For the metalized BOPP film capacitors, the end spray process need to be well controlled to ensure no heat damage to the metalized film. The conventional BOPP film starts to shrink to different degrees above 105° C., dependent on the suppliers. According to a description by SB Electronics³, the electrode-to-spray interface along the connecting edge became disconnected in large areas when failed. In a separate report, Zhonghua Kong et al⁴ reported that the metalized PP (conventional) film capacitors would blow out from the middle location of capacitors when surface temperature of capacitor is higher than 110° C.

With the high-temperature dimensional stability, HTLS PP films, as shown above, have 60° C. more room for end spray than the conventional BOPP films. The metal spray may be deeper into between films. The connection of end spray with metalized HTLS PP film capacitors is expected sturdier. HTLS PP film itself is more dimensionally stable in the high temperatures. Together, both benefits will add a great deal of values to the metalized HTLS PP film capacitors.

A roll of HTLS PP film having a thickness of 12 micron and 20 inch wide (Dielectric Film A) was masked with a strip of the same film (1 inch wide) in the middle of the film, then corona-treated to a 42 dyne/cm level on the side of strip and then metalized with Aluminum in a metalizer for an optical density of 3.3 (0.9 ohm/in²). The masked film was then removed for a metalized film with a clear unmetalized strip in the middle of the metalized film. The metalized film then was slit into two 3-inch-wide metalized strips: one having a ¼-inch clear unmetalized edge on the right; the other having a ¼-inch clear unmetalized edge on the left. These two metalized strips were then wound up on a 1.5 inch paper core for a metalized film capacitor. The metalized film capacitor was then sealed both ends by zinc end spray for uniform electrical conduction to the two electrodes separately. The capacitance of this metalized film capacitor at room temperature is 21 microFarad measured by a RadioShack hand-held digital multimeter. Then put this metalized film capacitor into a convection oven at 140° C. for 1 hour and take it out for capacitance measurement. The reading was 20.1 microFarad right out of oven and then reversibly back to about 21 microFarad when cooled down. No degradation of capacitance was observed. After heated for 1 hour at 140° C., no blow out was observed, and no any disconnection of the electrode-to-spray interface was observed.

What claimed is:

1. A semi-crystalline polymeric capacitor-use dielectric film, the thickness of which ranges from 1 micron to 80 micron, made by an extrusion melt-stretching process through a die (either circular die or flat die) with a drawdown ratio of 30 or higher (the ratio of die gap to the film thickness) at die temperatures higher than the melting point of said semi-crystalline polymer.

2. The semi-crystalline polymeric capacitor-use dielectric film according to claim#1 made of a semi-crystalline polymer selected from high-density polyethylenes, polypropylenes, polybutanes, polybutylenes, polypentenes, PVDF, PET, PEN, Nylon, their copolymers, or their melt blends.

3. The semi-crystalline polymeric capacitor-use dielectric film according to claim#1 either in a single layer form or in a multilayer composite form.

4. The semi-crystalline polymeric capacitor-use dielectric film according to claim#1 made of polypropylene, having a shrinkage of less than 1% in the machine direction and in the transverse direction at 130° C.

5. The semi-crystalline polymeric capacitor-use dielectric film according to claim#1 made of polypropylene, having a shrinkage of less than 1% in the machine direction and in the transverse direction at 140° C.

6. The semi-crystalline polymeric capacitor-use dielectric film according to claim#1 made of polypropylene, having a shrinkage of less than 1% in the machine direction and in the transverse direction at 150° C.

7. The semi-crystalline polymeric capacitor-use dielectric film according to claim#1 made of polypropylene, having a shrinkage of less than 1% in the machine direction and in the transverse direction at 155° C.

8. The semi-crystalline polymeric capacitor-use dielectric film according to claim#1 made of polypropylene, having a shrinkage of less than 1% in the machine direction and in the transverse direction at 160° C.

9. A film capacitor comprising (1) of electric conduction electrodes and (2) of semi-crystalline polymeric dielectric film(s), the thickness of which ranges from 1 micron to 80 micron, made by an extrusion melt-stretching process through a die (circular die or flat die) with a drawdown ratio of 30 or higher (the ratio of die gap to the film thickness) at die temperatures higher than the melting point of said semi-crystalline polymer(s).

10. The film capacitor according to claim #9 having a semi-crystalline polymeric dielectric film selected from high-density polyethylenes, polypropylenes, polybutanes, polybutylenes, polypentenes, PVDF, PET, PEN, Nylon, their copolymers, their melt blends in a monolayer form or in multi-layer composites.

11. The film capacitor according to claim #10 having metal foils as electric conduction electrodes.

12. The film capacitor according to claim #10 having metalized electrodes.

13. The film capacitor according to claim #11 or claim #12 comprising a polypropylene film as dielectric.

14. The film capacitor according to claim #13 having a polypropylene dielectric film made by a melt-stretching blown-film extrusion process with a circular die.

15. The film capacitor according to claim #13 having a polypropylene dielectric film having a shrinkage of less than 1.0% at 130° C.

16. The film capacitor according to claim #13 having a polypropylene dielectric film having a shrinkage of less than 1.0% at 140° C.

17. The film capacitor according to claim #13 having a polypropylene dielectric film having a shrinkage of less than 1.0% at 150° C.

18. The film capacitor according to claim #13 having a polypropylene dielectric film having a shrinkage of less than 1.0% at 155° C.

19. The film capacitor of claim #13 having a polypropylene dielectric film having a shrinkage of less than 1.0% at 160° C.
